(19) United States
(12) Patent Application Publication
(10) Pub. No.: US 2003/0223749 A1
(43) Pub. Date: Dec. 4, 2003

(54) Optical network management

(76) Inventors: David Funk, Berowra Heights (AU); Gregory Tunnock, Eastwood (AU); Andrew Koschier, Eastwood (AU); Christopher Fegan, Darlington (AU)

Correspondence Address: CHRISTIE, PARKER & HALE, LLP, 350 WEST COLORADO BOULEVARD, SUITE 500, PASADENA, CA, 91105, US

(21) Appl. No.: 10/160,987

(22) Filed: May 31, 2002

(51) Int. Cl. H04B 10/20

(52) U.S. Cl. 398/59

(57) ABSTRACT

A method of distributing IP routing information between elements of an optical ring or spur network for network management, the method comprising the step of assigning a control interface module to each network element, wherein each interface module has first and second point-to-point link ports to its two neighbouring interface modules respectively, and assigning an IP address and sub-netmask to each link port.

### FIELD OF THE INVENTION

The present invention relates broadly to a method of distributing IP routing information between elements of an optical ring or spur network for network management, to a management system for an optical ring or spur network, and to an optical ring or spur network.

### BACKGROUND OF THE INVENTION

It has been proposed in co-pending U.S. patent application Ser. No. 09/755847, entitled “Network management” filed on Jan. 5, 2001 and assigned to the assignee of the present application, to manage an optical network utilising internet protocol (IP).

The applicants have recognised that it would be desirable to develop an IP routing information protocol for such optical networks, which is specifically suitable for use in optical ring or spur networks. Prior art routing information protocols such as Routing Information Protocol (RIP) or Open Shortest Path First (OSPF) were found by the applicant not to be suitable. For example, RIP considers 16 hops in a network to be an infinite loop. Even if RIP was modified to cater for a larger number of hop rings, i.e. a larger number of network interface modules, it is believed not to meet tight convergence requirements of e.g. no more than 15 seconds network management outage arising from a fibre break in an optical ring network.

On the other hand, while OSPF could meet larger optical network sizes in terms of number of network interface modules, topology and convergent requirements, the applicants have found that it is not suitable for simple embedded implementation in an optical network due to its complexity. OSPF is particularly not suitable for implementation in an outside plant (OSP) environment. This is because the significant processing requirements conflict with limitations in terms of physical size and power consumption faced in an OSP situation.

The present invention, in at least preferred embodiments, seeks to provide a novel routing information protocol suitable for optical ring or spur networks.

### SUMMARY OF THE INVENTION

In accordance with a first aspect of the present invention there is provided a method of distributing IP routing information between network elements of an optical ring or spur network for network management, the method comprising the step of assigning a control interface module to each network element, wherein each interface module has first and second point-to-point link ports to its two neighbouring interface modules respectively, and assigning an IP address and sub-netmask to each link port.

Preferably, each interface module has zero or more gateway link ports, the method further comprises assigning an associated IP address and sub-netmask to each gateway link port.

The method may further comprise the step of advertising all directly reachable IP subnet addresses for each interface module to all other interface modules, and wherein all directly reachable IP subnet addresses for one interface module are advertised to both its neighbouring interface modules.

All directly reachable IP subnet addresses for each interface module may be advertised periodically to both its neighbouring interface modules. All directly reachable IP subnet addresses for each interface module may be advertised about every 5 seconds.

In one embodiment, all directly reachable IP subnet addresses for one interface module are advertised event driven when a change occurs in the directly reachable IP subnet addresses for said one interface module.

The method may further comprise the step of preventing event driven advertisements from being sent if a frequency of changes in the reachable IP subnet addresses is higher than a predetermined value.

In one embodiment, the step of advertising all directly reachable IP subnet addresses for each interface module to all other interface modules preferably comprises, at each interface module, the steps of receiving a subnet advertisement list from one neighbouring interface module, removing all subnet addresses directly reachable from said each interface module and all subnet addresses which are below these on said received subnet advertisement list if the received subnet advertisement includes such subnet addresses, adding all subnet addresses directly reachable from said each interface module at the beginning of the received subnet advertisement list, and sending the modified received subnet advertisement list to the other neighbouring interface module of said each interface module.

The step of adding all subnet addresses directly reachable from said each interface module at the beginning of the received subnet advertisement list may further comprise utilising a delimiter at the beginning or end of all subnet addresses directly reachable from said each interface module. The delimiter may comprise a loopback network address.

In one embodiment, the last received subnet advertisement lists on the first and second point-to-point link ports are stored at each interface module for updating a routing table for said each interface module. The routing table may be updated such that IP packets will be forwarded from each interface module to a destination subnet address along a direction in which the smaller number of interface modules is encountered prior to reaching the destination subnet address.

Where a subnet advertisement list is not received at one of the point-to-point link ports of one of the interface modules after a predetermined period, the method may further comprise the steps of, at said one interface module removing all subnet addresses directly reachable from the interface module from which the subnet advertisement list was expected from the subnet advertisement list stored at said one interface module, removing all subnet addresses directly reachable from said one interface module and all subnet addresses which are below these on said stored subnet advertisement list if the stored subnet advertisement list includes such subnet addresses, adding all subnet addresses now directly reachable from said one interface module at the beginning of said stored subnet advertisement list, and sending the modified stored subnet advertisement list to the other neighbouring interface module of said one interface module. In one embodiment, the method further comprises the step of, at said one interface module, removing the subnet address of the interface module from which the subnet advertisement list was expected from a routing table for said one interface module. The predetermined period may be about every 15 seconds.

Each gateway link port of at least one interface module further may have an associated default gateway address, and the step of advertising all directly reachable IP subnet addresses for said at least one interface module may comprise advertising said default gateway address.

One or more of the link ports of at least one interface module can be capable of being disabled.

In accordance with a second aspect of the present invention, there is provided a control system for an optical ring or spur network comprising a plurality of control interface modules each assigned, in use, to one element of the optical network intended for control, each interface module having first and a second point-to-point link ports to its two neighbouring interface modules respectively, wherein each link port has an associated IP address and sub-netmask.

Preferably, each interface module has zero or more gateway link ports, wherein each gateway link port has an associated IP address and sub-netmask.

In one embodiment, the system comprising a management unit associated with each interface module and arranged, in use, to advertise all directly reachable IP subnet addresses for said each interface module to both its neighbouring interface modules.

Each management unit may be arranged, in use, such that all directly reachable IP subnet addresses for the interface module associated with said each management unit are advertised periodically to both its neighbouring interface modules. All directly reachable IP subnet addresses for each interface module may be advertised about every 5 seconds.

In one embodiment, each management unit is arranged, in use, such that all directly reachable IP subnet addresses for one interface module are advertised event driven when a change occurs in the directly reachable IP subnet addresses for the interface module associated with said each management unit. Each management unit may be further arranged, in use, to prevent event driven advertisements from being sent if a frequency of changes in the reachable IP subnet addresses is higher than a predetermined value.

In one embodiment, each management unit preferably comprises a receiving unit for receiving a subnet advertisement list from one neighbouring interface module, a processing unit for removing all subnet addresses directly reachable from the interface module associated with said each management unit and all subnet addresses which are below these on said subnet advertisement list if the received subnet advertisement includes such subnet addresses, and for adding all subnet addresses directly reachable from said interface module at the beginning of the received subnet advertisement list, and a sending unit for sending the modified received advertisement list to the other neighbouring interface module of said interface module.

The receiving unit may be arranged to receive subnet advertisement lists from both neighbouring interface modules. The receiving unit may be in the form of two receiving elements, one for receiving a subnet advertisement list from each neighbouring interface module.

In one embodiment, the processing unit is arranged, in use, such that in the adding of all subnet addresses directly reachable from said interface module to the received subnet advertisement list a delimiter is utilised at the beginning or end of all subnet addresses reachable from said interface module. The delimiter may comprise a loopback network address.

Each management unit may further comprise a database for storing the last received subnet advertisement lists on both network ports for updating a routing table in said database for the interface module associated with said each management unit.

The database may be configured such that, in use, the routing table is updated such that IP packets will be forwarded from each interface module to a destination subnet address along a direction in which the smaller number of interface modules is encountered prior to reaching the destination subnet address.

In one embodiment, the receiving unit of each management unit is arranged, in use, such that, where a subnet advertisement list is not received at one of the network ports of one of the interface modules after a predetermined period, the processing unit is activated to remove all subnet addresses directly reachable from the interface module from which the subnet advertisement list was expected from the subnet advertisement list stored for the interface module associated with said each management unit, to remove all subnet addresses directly reachable from said interface module and all subnet addresses which are below these on said stored subnet advertisement list if the stored subnet advertisement list includes such subnet addresses, and to add all subnet addresses now directly reachable from said interface module at the beginning of said stored subnet advertisement list, and the sending unit is activated to send the modified stored subnet advertisement list to the other neighbouring interface module of said interface module.

In one embodiment, the management unit is further arranged such that, in use, the database is modified by removing the subnet address of the interface module from which the subnet advertisement list was expected from a routing table for said interface module. The predetermined period may be about every 15 seconds.

Each gateway link port of at least one interface module may further have an default gateway address associated with it, and management unit associated with said one interface module is arranged, in use, to advertise said default gateway address as part of the directly reachable IP subnet addresses for said one interface module.

One or more of the link ports of at least one interface module may be capable of being disabled.

The system may be capable of being implemented in an outside plant (OSP) environment.

In accordance with a third aspect of the present invention there is provided an optical ring or spur network comprising a network management system of the second aspect.

### BRIEF DESCRIPTION OF THE DRAWINGS

Preferred embodiments will now be described by way of example only, with reference to the accompanying drawings.

FIG. 1 shows schematically a network topology (data plane) of a bidirectional WDM optical network embodying the present invention.

FIG. 2 shows schematically the network topology (control plane) of the optical network of FIG. 1.

FIG. 3 shows an address assignment scheme for IP subnet addresses in an example embodiment.

FIG. 4 shows the logical flow of a routing information protocol embodying the present invention.

FIG. 5 is a table illustrating the build-up of routing information protocol data in an optical network, embodying the present invention.

FIGS. 6 A to D show a table illustrating a snapshot of sent and stored subnet advertisements at each point-to-point port of elements of an optical network, embodying the present invention.

FIG. 7 shows schematically the network topology (control plane) of another optical network embodying the present invention.

FIGS. 8 A and B show a routing table embodying the present invention.

### DETAILED DESCRIPTION OF THE EMBODIMENTS

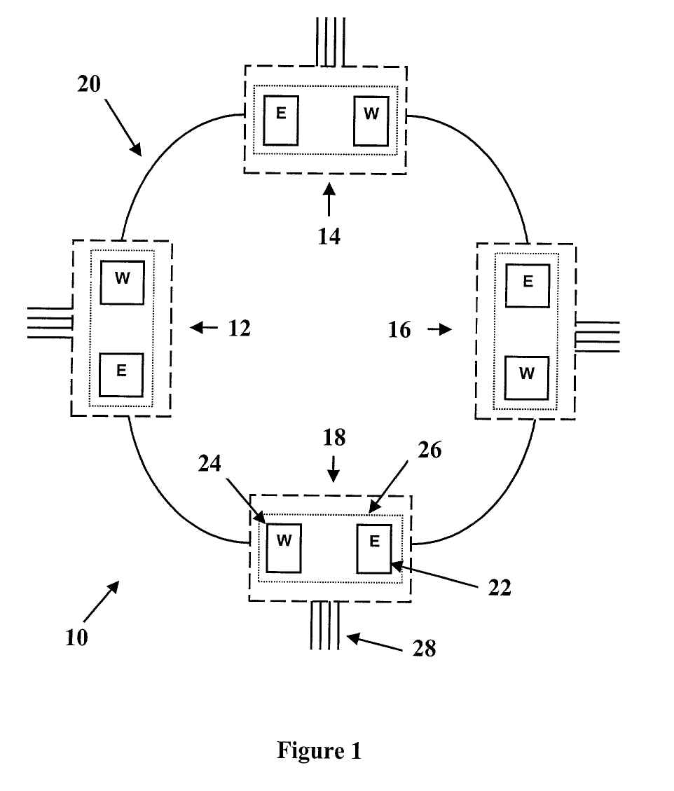

FIG. 1 shows the network topology (data plane) of a bi-directional wavelength division multiplexed (WDM) optical network 10 having a plurality of network nodes 12, 14, 16, 18 linked in a ring configuration by single-fibre bi-directional links e.g. 20. Each network node e.g. 18 comprises an east network interface module (NIM) 22 and a west NIM 24. The east and west NIMs form part of reconfigurable add/drop multiplexer (RADMs) e.g. 26 for adding/dropping WDM channel signals to and from tributary lines e.g. 28 connected to the network node 18 done.

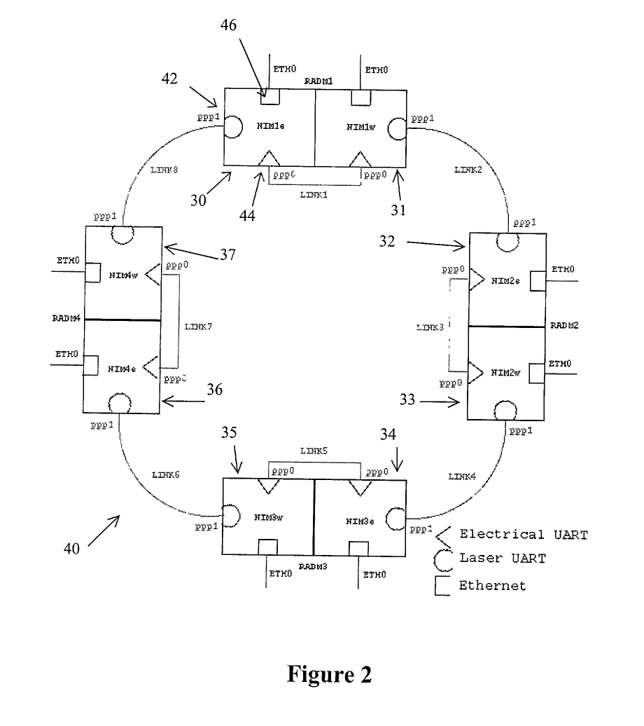

FIG. 2 shows the network topology (control plane) of the optical network 10 of FIG. 1. In the control plane shown in FIG. 2, each NIM 30 to 37 forms an element of the management network 40. Each NIM e.g. 30 has two point-to-point link ports 42, 44 and a gateway link port in the form of an ethernet port 46. In the embodiment shown in FIG. 2, the point-to-point link ports e.g. 42 which interface between neighbouring NIMs physically located in another RADM of the network 10 (see FIG. 1) are in the form of optical universal asynchronous receiver transmitter (UART) interfaces, whereas the point-to-point link ports e.g. 44 interfacing to the neighbouring NIM 31 located in the same RADM are in the form of electrical UART interfaces. It will be appreciated by a person skilled in the art that other point-to-point transmission could be used in different embodiments, e.g. HDLC (High Level Data Link Control) controller chips.

In the management network topology 40, each of the ethernet links e.g. 46 may be connected to a local area network (LAN) (not shown) for facilitating management input/output, e.g. at a central office location (not shown).

In the embodiment shown in FIG. 2, the management network 40 is in the form of a IP network management network which runs over an embedded optical channel EOC on the optical network 10 (see FIG. 1). Furthermore, routed networking technologies are utilised for distribution of management information.

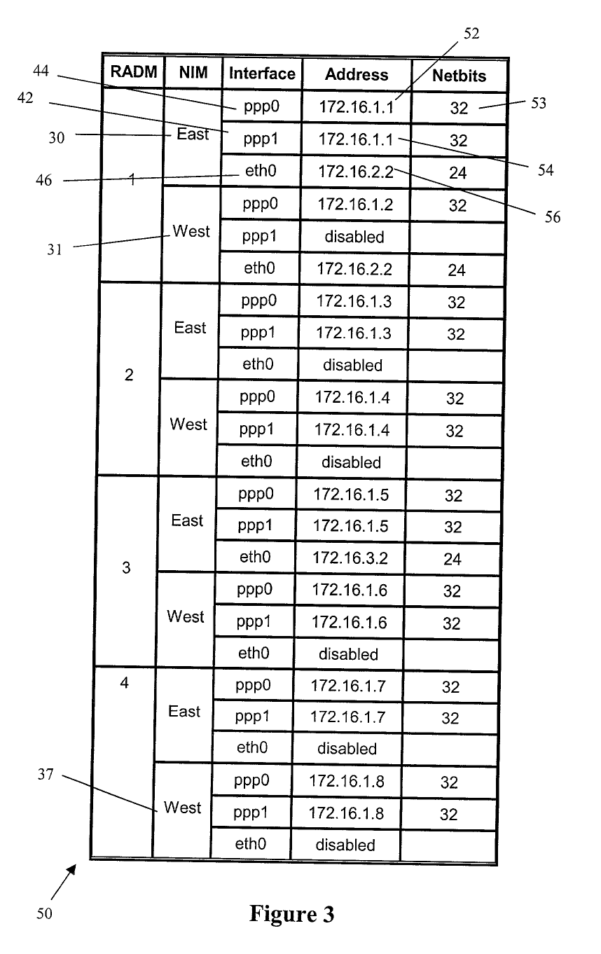

FIG. 3 shows an address assignment scheme 50 for IP subnet addresses in the example embodiment for the management network 40 (see FIG. 2). In the address assignment scheme 50, for each of the NIMs 30-37, their link interfaces e.g. 42, 44, and 46 have IP addresses ,e.g. 52, 54 and 56 respectively, and sub-net masks e.g. 53, assigned to them, where, in the example embodiment, Netbits=32 corresponds to Netmask=255.255.255.255 and Netbits=24 corresponds to Netmask=255.255.255.0. It will be appreciated by a person skilled in the art that an IP address and sub-net mask specifies a unique IP address and the range of addresses for the sub-network that that IP address is within.

The IP addressing scheme illustrated in FIG. 3 has the following characteristics:

an IP address is allocated to the RADM (see FIG. 1) from the Craft User Interface (CUI).

the RADM IP address is assigned to one of the NIMs.

the RADM IP address can only be an odd address—CUI rejects even addresses.

the IP address one more than the RADM IP address is assigned to the other NIM.

both point-to-point interfaces on a NIM take the one IP address of the NIM.

the ethernet interface on an NIM takes an IP address on a different subnet to the RADM subnet.

In the following, the routing information protocol of the example embodiment will be described. The key elements of the example routing information protocol embodying the present invention are:

advertise reachable subnet addresses for each NIM to all other NIMs on the EOC management network.

advertise reachable subnet addresses in both directions along the EOC management network.

update each NIM's routing table from the advertised reachable sub-network addresses received.

update each NIM's routing table so IP packets will be forwarded in the direction (east or west) that is shorter to their destination.

periodically send all directly reachable sub-network address advertisements, each 5 seconds in the example embodiment.

when a NIM changes its routing table for any reason, resend all advertisements immediately—event driven.

disable the beforementioned resending if the NIM changes occur at a frequency higher than a predetermined threshold value.

a NIM will delete all routes added from advertisements after it has not received any advertisements for 15 seconds in the example embodiment.

if a NIM is configured with a default gateway router address, it will advertise the default gateway address (0.0.0.0/0).

maintain EOC management network topology information at each NIM.

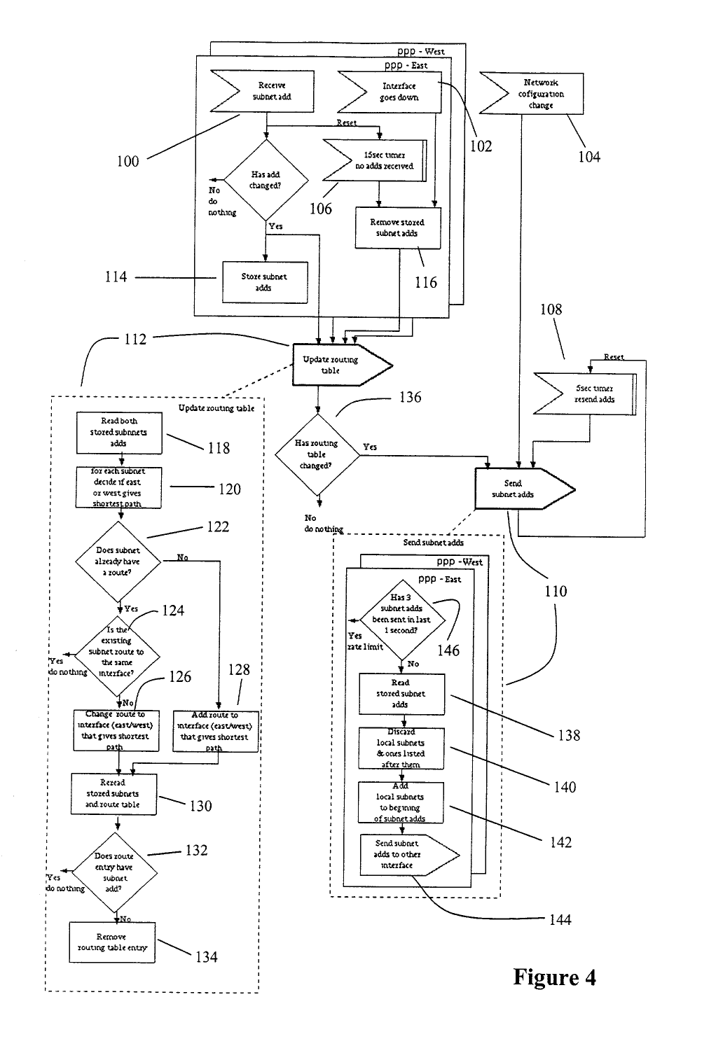

FIG. 4 shows the logical flow of the example routing information protocol. The inputs to the routing information protocol are:

subnet advertisements from neighbours (step 100).

notification of east or west point-to-point interface going down (step 102).

network configuration change from the management interface (step 104).

no subnet advertisement received timer (step 106), in the example embodiment 15 seconds, and

resend subnet advertisement timer (step 108), in the example embodiment 5 seconds.

The outputs from the routing information protocol are:

sending the subnet advertisement to both neighbours (step 110).

updating the routing tables (step 112).

The routing information protocol embodying the present invention exchanges routing information between neighbours. Neighbour discovery in the example embodiment is facilitated by inquiring the other-end-address of the point-to-point links/interfaces connected to the neighbouring NIMs for each NIM.

In the example embodiment, the last subnet advertisement received on each point-to-point link port is stored at each NIM (step 114). The stored subnet advertisements are used to update routing tables and when sending subnet advertisements of all directly reachable IP subnet addresses to the neighbouring NIMs.

In the example embodiment a NIM expects to receive subnet advertisements from both neighbours at least every 15 seconds. If it doesn't receive a subnet advertisement from a neighbour for 15 seconds it is assumed that the neighbour's routing information protocol application has died and the neighbour is in an unknown state. When this occurs, the stored subnet advertisements for the dead neighbour are deleted, (step 116), the routes using the point-to-point link port to the dead neighbour are removed from the routing table, and (updated) subnet advertisements are resent to both neighbours.

If a point-to-point link port goes down, the routes using that point are removed from the routing table immediately. Updated subnet advertisements are sent out each of the two point-to-point link ports whenever a routing table update occurs (step 136).

In updating the routing table, the stored subnet advertisements for both point-to-point interfaces are read (step 118). For each subnet, it is decided if the east or west point-to-point interface gives the shorter path (step 120).

A determination is then made whether a subnet already has a route in the routing table (step 122). If yes, a further determination of whether the existing subnet route is to the same interface is made (step 124). If yes, no update occurs and the updating routine is ended for that subnet. If no, the route is changed to the interface that gives the shorter path (step 126).

If the determination at step 122 above is “no”, then a route to the interface that gives the shorter path is added (step 128).

When the routine (steps 120, 122, 124, 126, 128) is finished, the stored (modified) subnets and route table are re-read (step 130).

A final determination is made whether each route entry has an associated subnet (step 132). If yes, the updating is concluded, if no, that particular routing table entry or entries are removed (step 134) as these subnets are no longer contactable.

Subnet advertisements sent to a neighbour are formed by taking the subnet advertisement received from the opposing neighbour (step 138) , removing subnet entries that this NIM can deliver directly to (local subnets) and any subnet entries after these in the received subnet advertisement (step 140). Then, the NIM's local subnets are added to the front of the received subnet advertisement (step 142), and the modified subnet advertisement is sent to the other neighbour (step 144). Removing the subnet entries after the NIM's local subnets catches the case where another NIM has had its address changed or has been removed from the ring. The NIM's own subnets should normally be the last, as the routing protocol will have effectively travelled back to where it came from during the distribution of routing information through the network. It is noted that at the beginning of the subnet sending routine, a determination is made whether three subnet advertisements have been sent, in the example embodiment, in the last second (step 146). If yes, the routine is stopped, i.e. no subnet advertisement is sent. This is to guard against an intermediately faulty point-to-point interface causing consumption of an excessive amount of EOC bandwidth.

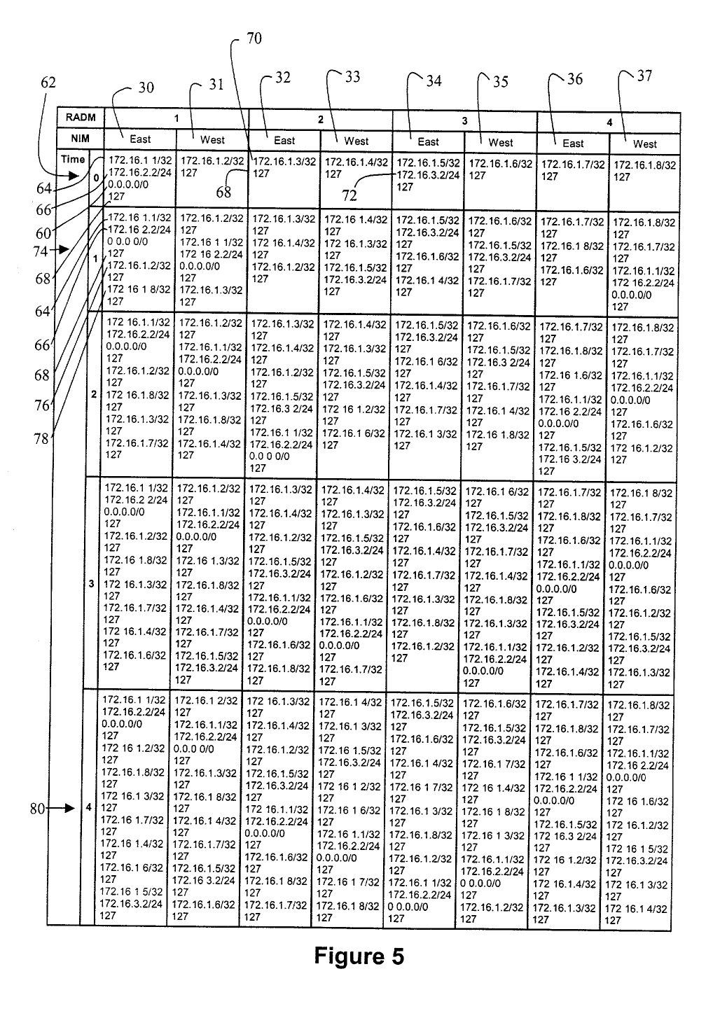

FIG. 5 shows the build up of routing information protocol data at each of the NIMs around the management network ring 40 (see FIG. 2) of the example embodiment. In FIG. 5, the addressing scheme 50 of FIG. 3 for the example embodiment has been used, together with the assignment of a default gateway router address 60 to the NIM 30.

In FIG. 5, the entries in the row 62 for time zero are all the subnet addresses that are locally know at each NIM 30-37. For example, NIM 30 knows, in addition to gate router addresses 60, the IP subnet address 64 for its point-to-point link ports, (both point-to-point link ports are assigned the same IP subnet address, compare address assignment scheme 50 in FIG. 3). NIM 30 further knows the IP subnet address 66 for its ethernet link port. A delimiter 68 is utilised in the example embodiment.

At time zero, the rest of the NIMs 31-37, with the exception of NIM 34, only know the IP subnet addresses for their point-to-point link ports, e.g. 70 for NIM 32, and use the delimiter 68.

NIM 34 also knows the IP subnet address 72 for its ethernet link port, because, in the example embodiment, it is the second NIM that has its ethernet link port enabled (compare address assignment scheme 50 in FIG. 3). However NIM 34 does not have a default gateway enabled.

The next row 74 illustrates the information at each NIM after the first subnet advertisements have been exchanged. Thus, each NIM now knows, in addition to its local connected IP subnet addresses, the IP subnet addresses of its neighbours.

For example NIM 30 knows (starting from the top) its local IP subnet addresses 64, 66, and 60, and it now also knows its neighbours' local subnet addresses 76, 78 respectively.

It will be appreciated by the person skilled in the art that through subsequent periodic advertising of the routing information “knowledge” accumulated at each NIM to its neighbours, a complete subnet discovery takes place at each NIM, to a point at time four where the entries at each NIM in row 80 provide the complete management network topology. In other words, from that point onwards, up until a change occurs, the network topology could be determined from an inquiry to a single NIM.

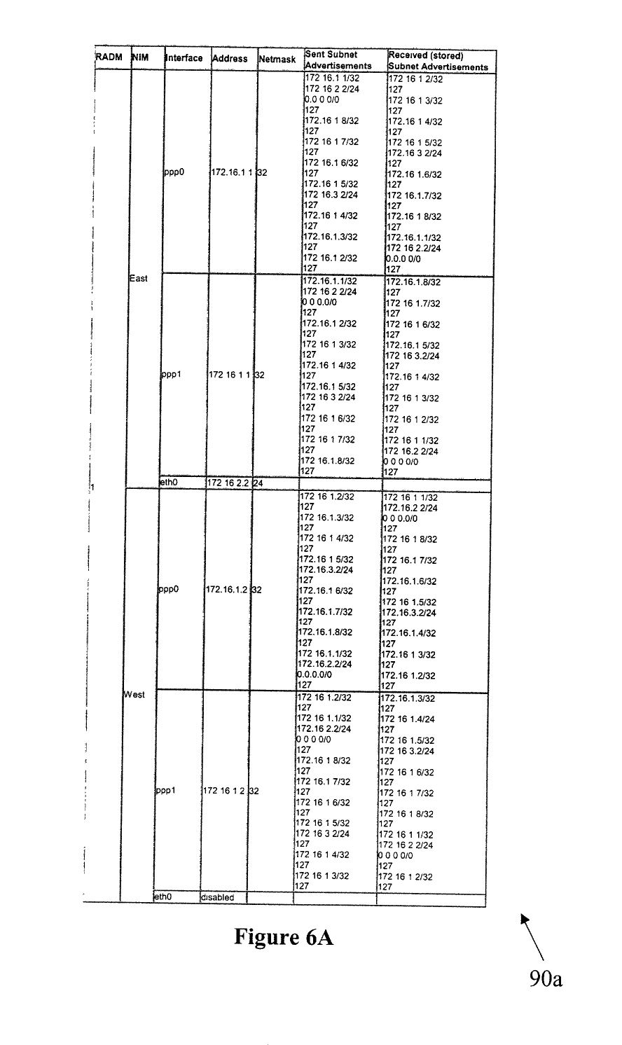

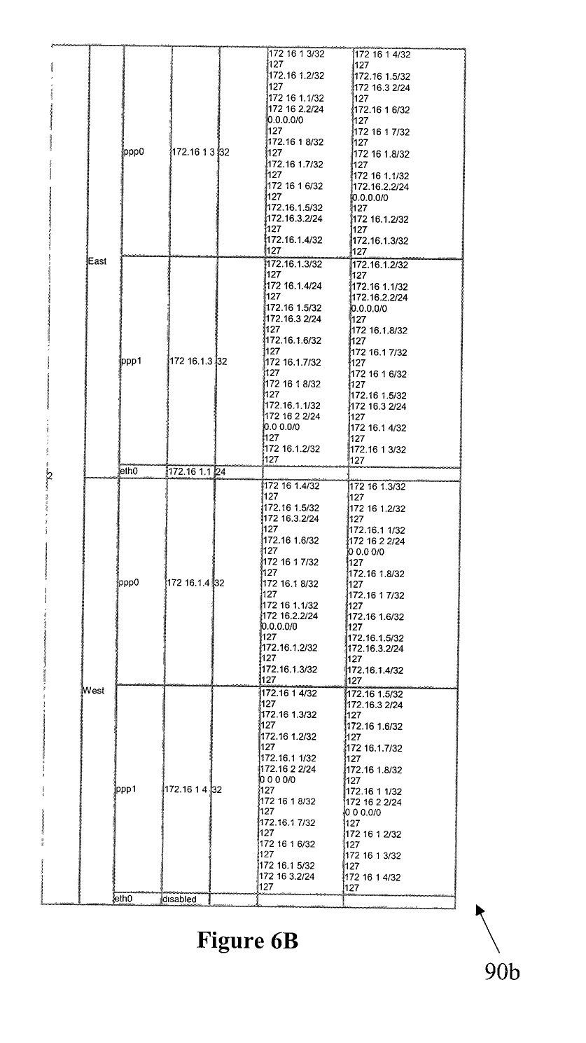

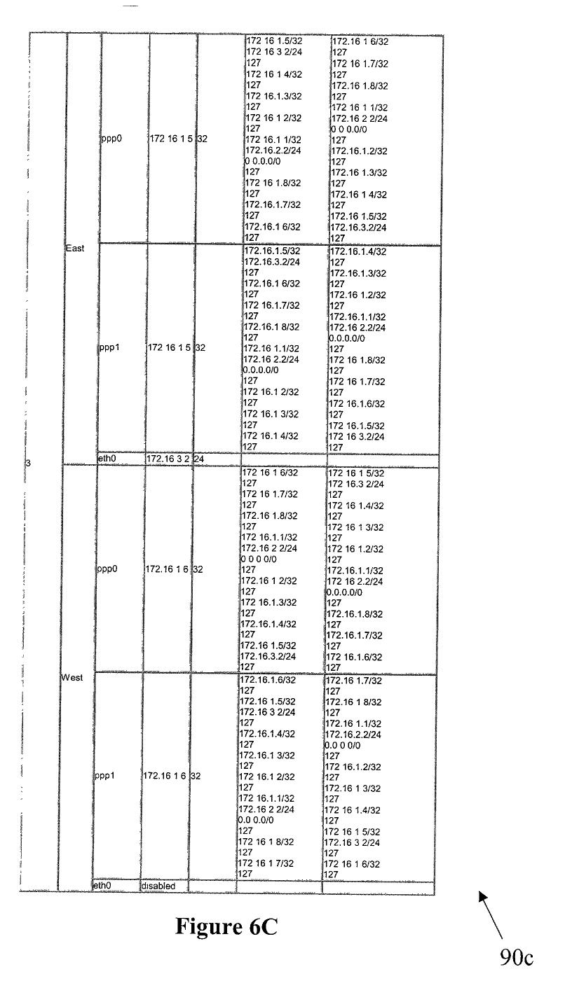

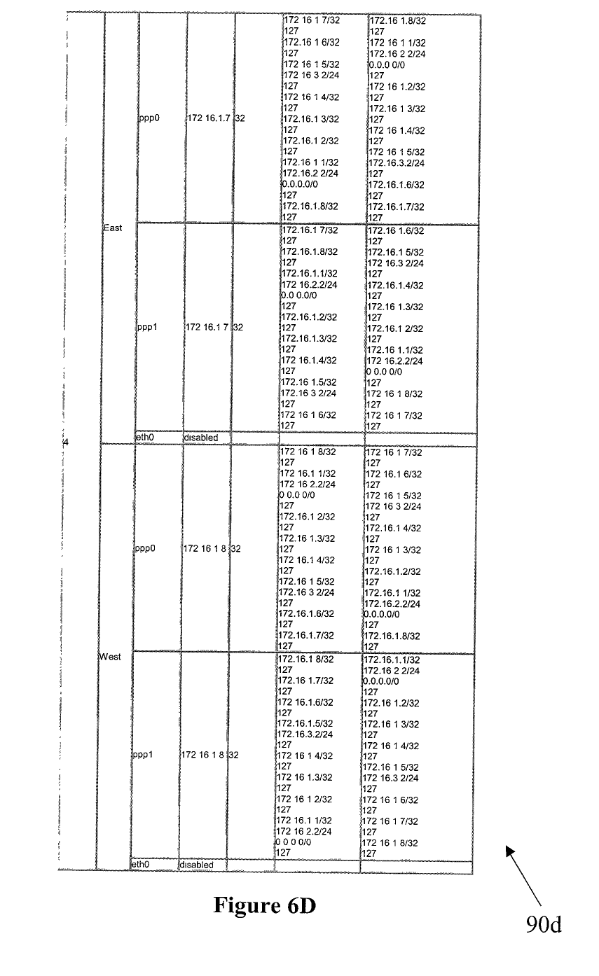

In FIGS. 6A to D, a more detailed snapshot 90a to 90d of sent and stored subnet advertisements at each point-to-point port of the NIMs 30-37 is shown for a time equal or greater than time four (compare FIG. 5).

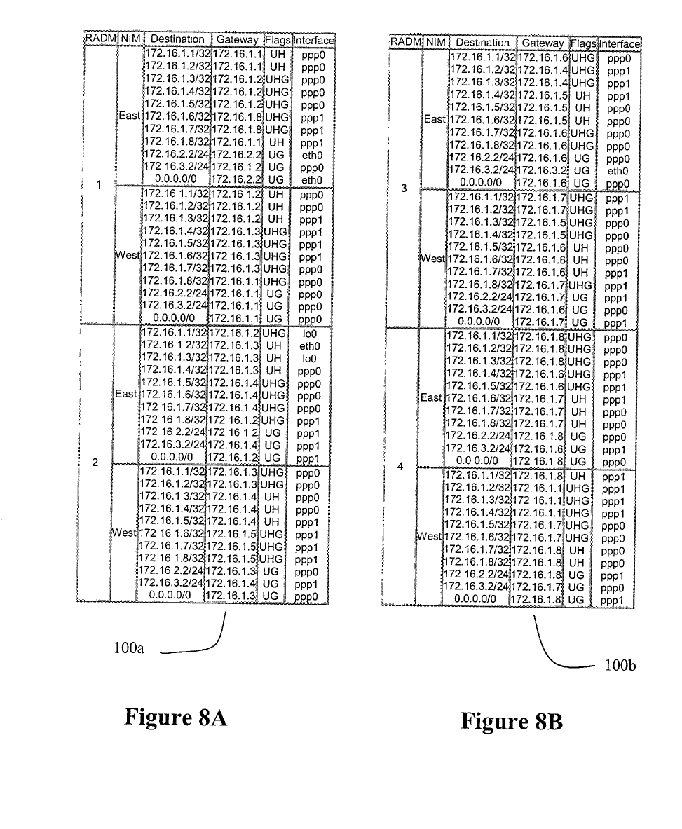

In FIGS. 8A and B, a resulting example routing table 100a, b is shown.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

For example, IP addressing schemes other than the one described for the example embodiment (compare FIG. 3) can be used in different embodiments of the present invention.

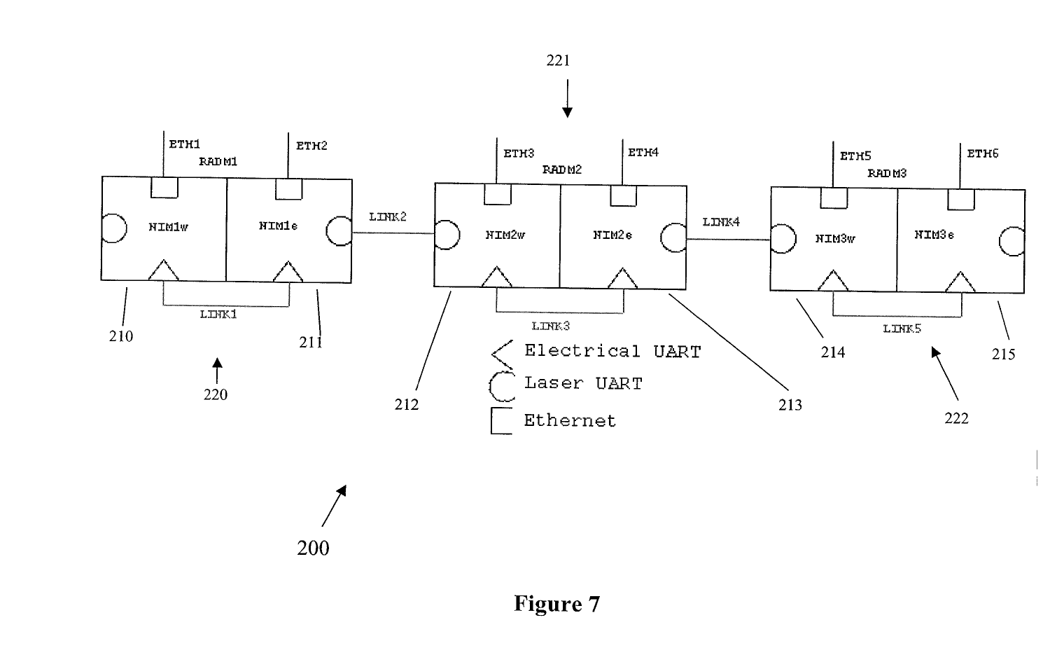

Furthermore, the present invention is not limited to optical ring networks, but rather can be implemented also in a spur network configuration. FIG. 7 shows the network topology (control plane) of an optical spur network 200 including NIMs 210-215 associated with three separate RADMs 220, 221, and 222.

In the claims that follow and in the summary of the invention, except where the context requires otherwise due to express language or necessary implication the word “comprising” is used in the sense of “including”, i.e. the features specified may be associated with further features in various embodiments of the invention.

1. A method of distributing IP routing information between network elements of an optical ring or spur network for network management, the method comprising the step of assigning an control interface module to each network element, wherein each interface module has first and second point-to-point link ports to its two neighbouring interface modules respectively, and assigning an IP address and sub-netmask to each link port.

2. A method as claimed in claim 1, wherein each interface module has zero or more gateway link ports, the method further comprises assigning an associated IP address and sub-netmask to each gateway link port.

3. A method as claimed in claims 1 or 2, wherein the method further comprises the step of:
advertising all directly reachable IP subnet addresses for each interface module to all other interface modules, and
wherein all directly reachable IP subnet addresses for one interface module are advertised to both its neighbouring interface modules.

4. A method as claimed in claim 3, wherein all directly reachable IP subnet addresses for each interface module are advertised periodically to both its neighbouring interface modules.

5. A method as claimed in claim 4, wherein all directly reachable IP subnet addresses for each interface module are advertised about every 5 seconds.

6. A method as claimed in claim 5, wherein all directly reachable IP subnet addresses for one interface module are advertised event driven when a change occurs in the directly reachable IP subnet addresses for said one interface module.

7. A method as claimed in claim 6, wherein the method further comprises the step of preventing event driven advertisements from being sent if a frequency of changes in the reachable IP subnet addresses is higher than a predetermined value.

8. A method as claimed in claim 3, wherein the step of advertising all directly reachable IP subnet addresses for each interface module to all other interface modules preferably comprises, at each interface module, the steps of:
receiving a subnet advertisement list from one neighbouring interface module,
removing all subnet addresses directly reachable from said each interface module and all subnet addresses which are below these on said received subnet advertisement list if the received subnet advertisement includes such subnet addresses,
adding all subnet addresses directly reachable from said each interface module at the beginning of the received subnet advertisement list, and
sending the modified received subnet advertisement list to the other neighbouring interface module of said each interface module.

9. A method as claimed in claim 8, wherein the step of adding all subnet addresses directly reachable from said each interface module at the beginning of the received subnet advertisement list further comprises utilising a delimiter at the beginning or end of all subnet addresses directly reachable from said each interface module.

10. A method as claimed in claim 9, wherein the delimiter comprises a loopback network address.

11. A method as claimed in claim 3, wherein the last received subnet advertisement lists on the first and second point-to-point link ports are stored at each interface module for updating a routing table for said each interface module.

12. A method as claimed in claim 11, wherein the routing table is updated such that IP packets will be forwarded from each interface module to a destination subnet address along a direction in which the smaller number of interface modules is encountered prior to reaching the destination subnet address.

13. A method as claimed in claim 3, wherein, where a subnet advertisement list is not received at one of the point-to-point link ports of one of the interface modules after a predetermined period, the method further comprises the steps of, at said one interface module:
removing all subnet addresses directly reachable from the interface module from which the subnet advertisement list was expected from the subnet advertisement list stored at said one interface module,
removing all subnet addresses directly reachable from said one interface module and all subnet addresses which are below these on said stored subnet advertisement list if the stored subnet advertisement list includes such subnet addresses,
adding all subnet addresses now directly reachable from said one interface module at the beginning of said stored subnet advertisement list, and
sending the modified stored subnet advertisement list to the other neighbouring interface module of said one interface module.

14. A method as claimed in claim 13, wherein the method further comprises the step of, at said one interface module, removing the subnet address of the interface module from which the subnet advertisement list was expected from a routing table for said one interface module.

15. A method as claimed in claims 13 or 14, wherein the predetermined period is be about every 15 seconds.

16. A method as claimed in claim 2, wherein the gateway link port of at least one interface module further has an associated default gateway address, and the step of advertising all directly reachable IP subnet addresses for said at least one interface module comprises advertising said default gateway address.

17. A method as claimed in claims 1 or 2, wherein one or more of the link ports of at least one interface module are capable of being disabled.

18. A control system for an optical ring or spur network comprising a plurality of control interface modules each assigned, in use, to one element of the optical network intended for control, each interface module having first and a second point-to-point link ports to its two neighbouring interface modules respectively, wherein each link port has an associated IP address and sub-netmask.

19. A system as claimed in claim 18, wherein each interface module has zero or more gateway link ports, wherein each gateway link port has an associated IP address and sub-netmask.

20. A system as claimed in claims 18 or 19, the system comprising:
a management unit associated with each interface module and arranged, in use, to advertise all directly reachable IP subnet addresses for said each interface module to both its neighbouring interface modules.

21. A system as claimed in claims 20, wherein each management unit is arranged, in use, such that all directly reachable IP subnet addresses for the interface module associated with said each management unit are advertised periodically to both its neighbouring interface modules.

22. A system as claimed in claim 21, wherein all directly reachable IP subnet addresses for each interface module are advertised about every 5 seconds.

23. A system as claimed in claim 20, wherein each management unit is arranged, in use, such that all directly reachable IP subnet addresses for one interface module are advertised event driven when a change occurs in the directly reachable IP subnet addresses for the interface module associated with said each management unit.

24. A system as claimed in claim 23, wherein each management unit is further arranged, in use, to prevent event driven advertisements from being sent if a frequency of changes in the reachable IP subnet addresses is higher than a predetermined value.

25. A system as claimed in claim 20, wherein each management unit preferably comprises:
a receiving unit for receiving a subnet advertisement list from one neighbouring interface module,
a processing unit for removing all subnet addresses directly reachable from the interface module associated with said each management unit and all subnet addresses which are below these on said subnet advertisement list if the received subnet advertisement includes such subnet addresses, and for adding all subnet addresses directly reachable from said interface module at the beginning of the received subnet advertisement list,
and a sending unit for sending the modified received advertisement list to the other neighbouring interface module of said interface module.

26. A system as claimed in claim 25, wherein the receiving unit is arranged to receive subnet advertisement lists from both neighbouring interface modules.

27. A system as claimed in claim 26, wherein the receiving unit is in the form of two receiving elements, one for receiving a subnet advertisement list from each neighbouring interface module.

28. A system as claimed in claim 25, wherein the processing unit is arranged, in use, such that in the adding of all subnet addresses directly reachable from said interface module to the received subnet advertisement list a delimiter is utilised at the beginning or end of all subnet addresses reachable from said interface module.

29. A system as claimed in claim 28, wherein the delimiter comprises a loopback network address.

30. A system as claimed in claim 25, wherein each management unit further comprises a database for storing the last received subnet advertisement lists on both network ports for updating a routing table in said database for the interface module associated with said each management unit.

31. A system as claimed in claim 30, wherein the database is configured such that, in use, the routing table is updated such that IP packets will be forwarded from each interface module to a destination subnet address along or direction in which the smaller number of interface modules is encountered prior to reaching the destination subnet address.

32. A system as claimed in claim 25, wherein the receiving unit of each management unit is arranged, in use, such that, where a subnet advertisement list is not received at one of the network ports of one of the interface modules after a predetermined period, the processing unit is activated to
remove all subnet addresses directly reachable from the interface module from which the subnet advertisement list was expected from the subnet advertisement list stored for the interface module associated with said each management unit,
to remove all subnet addresses directly reachable from said interface module and all subnet addresses which are below these on said stored subnet advertisement list if the stored subnet advertisement list includes such subnet addresses, and
to add all subnet addresses now directly reachable from said interface module at the beginning of said stored subnet advertisement list,
and the sending unit is activated to send the modified stored subnet advertisement list to the other neighbouring interface module of said interface module.

33. A system as claimed in claim 30, wherein the management unit is further arranged such that, in use, the database is modified by removing the subnet address of the interface module from which the subnet advertisement list was expected from a routing table for said interface module.

34. A system as claimed in claim 32 or 33, wherein the predetermined period is about every 15 seconds.

35. A system as claimed in claim 21, wherein the gateway link port of at least one interface module further has an default gateway address associated with it, and management unit associated with said one interface module is arranged, in use, to advertise said default gateway address as part of the directly reachable IP subnet addresses for said one interface module.

36. A system as claimed in claim 20 or 21, wherein one or more of the link ports of at least one interface module are capable of being disabled.

37. A system as claimed in claims 20 or 21, wherein the system is being implemented in an outside plant (OSP) environment.

38. An optical ring or spur network comprising a network management system as claimed in claim 20 or 21.
